(19) United States
(12) Patent Application Publication
(10) Pub. No.: US 2016/0054144 A1
(43) Pub. Date: Feb. 25, 2016

(54) Navigation Device and Method Thereof

(71) Applicants: MiTAC International Corp., Kuei San Township (TW); MiTAC Research (Shanghai) Ltd., Shanghai (CN)

(72) Inventor: Qing-Ming Wu, Shanghai (CN)

(21) Appl. No.: 14/594,854

(22) Filed: Jan. 12, 2015

(30) Foreign Application Priority Data
Aug. 22, 2014 (CN) 201410417961.2

(51) Int. Cl. G01C 21/36

(52) U.S. Cl. CPC G01C 21/3667

(57) ABSTRACT

A navigation device and a method thereof. The navigation device is applicable to a vehicle. The navigation includes an input module, a storing module, a routing module and a display module. The input module is used for inputting a start address, a destination address and a dimension data of the vehicle. The storing module is used for storing a plurality of sections, each of the sections have a geometric bending data, respectively. The routing module filters sections or bending roads consisted of multiple sections, which are passable by the vehicle, from each of the sections in accordance with the dimension data and the geometric bending data, and plans a navigation path in accordance with a filter result, the start address and the destination address. The display module displays each of the sections and the navigation path.

### CROSS-REFERENCE TO RELATED APPLICATION

This application claims the benefit of China Patent Application No. 201410417961.2, filed on Aug. 22, 2014, in the State Intellectual Property Office of the People's Republic of China, the disclosure of which is incorporated herein in its entirety by reference.

### BACKGROUND OF THE INVENTION

1. Field of the Invention

The present invention generally relates to a navigation device and a method thereof, and more particularly to the navigation device and method capable of planning a passable navigation path for a car according to dimension data of the car and geometric bending data of a road section.

2. Description of the Related Art

As electronic and communication technologies advance in recent years, various different portable devices including cellular phones and personal digital assistant (PDA) occupying very little space are introduced to the market continuously. Most portable electronic devices available in the market integrate a multiple of functions to improve their competitiveness. Besides the general photographing, telephone and network connection functions, the Global Positioning System (GPS), electronic map and navigation system are also integrated into a handheld communication device. In addition, an automobile computer equipped with an electronic map and a navigation software or an automobile navigation device becomes increasingly more popular and users can handle their positions by GPS or other positioning methods anytime and anywhere, while capable of finding the best route through the planning and guidance of the navigation system to go to a desired destination quickly and safely.

However, a general navigation device simply considers the basic limitations of the road to filter a section passable by a vehicle. The general basic limitations include the limit of road width, the limit of road height, the limit of road weight or the limit of type of the vehicle. In other words, the general navigation device just filters the road passable by the vehicle based on the limitations of the road width, road height, road weight or the type of the vehicle. If the car driven by a user is a large car such as a bus or a truck, the bus or truck cannot pass through a bending road in a route planned by the navigation device, and thus causing tremendous inconvenience to the user. Therefore, it is necessary to develop a navigation device and a method thereof that integrate geometric bending information of each section in an electronic map to provide users a reliable planned route.

In view of the aforementioned problems, the inventor of the present invention developed and designed a navigation device and a method thereof to overcome the drawbacks of the prior art and to improve industrial applications.

### SUMMARY OF THE INVENTION

Therefore, it is a primary objective of the present invention to provide a navigation device and a method thereof to overcome the problems of the conventional navigation device incapable of determining whether or not a car can pass through a section according to geometric bending data of the section and dimension data of the car, such that the car may be unable to pass through the navigation path planned by the navigation device.

To achieve the foregoing objective, the present invention provides a navigation device, applicable to a vehicle and comprising an input module, a storing module, a routing module and a display module. The input module is provided for inputting a start address, a destination address and dimension data of the vehicle. The storing module is provided for storing a plurality of sections, each having geometric bending data. The routing module is provided for filtering a bending road consisted of the section or the plurality of sections passable by the vehicle from each section according to dimension data and geometric bending data of each section, and planning a navigation path according to a filter result, the start address and the destination address. The display module is provided for displaying each section and the navigation path.

Preferably, the dimension data include a front suspension length, a shaft width, a shaft distance, a car length, a car width, a car height or a car weight of the vehicle, and the geometric bending data include a minimum internal turning radius, a minimum external turning radius or a road width.

Preferably, the minimum internal turning radius (r) satisfies the following equation:

$$r = \frac{{L}_{AB}}{2} ;$$

Wherein r is the minimum internal turning radius, and L_{AB} is the linear distance between a start point and an end point of a bending road consisted of at least two sections.

Preferably, the minimum external turning radius (R) satisfies the following equation:

R=r+W/2;

Wherein, R is the minimum external turning radius, r is the minimum internal turning radius, and W is the road width.

Preferably, the minimum external turning radius (R) satisfies the following equations:

R=\sqrt{(r+B)²+(l+d)²} and R=r±W;

Wherein, R is the minimum external turning radius, r is the minimum internal turning radius, B is the car width, l is the shaft distance, d is the front suspension length, and W is the road width.

Preferably, the shaft distance (l) satisfies the following equation:

$$l < \frac{L - d}{1.55} ;$$

Wherein, l is the shaft distance, L is the car length, and d is the front suspension length.

Preferably, each section further includes limit data, and the limit data include a vehicle type, a road load limit, a road height limit and a road width limit, and the routing module further filters each section passable by the vehicle according to the limit data and the dimension data.

Preferably, the routing module further filters the section or a bending road consisted of a plurality of the sections passable by the vehicle according to the equation

$${W}^{2} + 4 RW > 4 {B}^{2} + 8 rB + \frac{{L}^{2} + 1.1 Ld + 0.3025}{1.6650} ;$$

wherein W is the road width, R is the minimum external turning radius, r is the minimum internal turning radius, B is the car width, L is the car length, and d is the front suspension length, and if the geometric bending data of any of the sections fail to satisfy said equation, the routing module will determine that the vehicle is unable to pass through the section.

To achieve the objective of the present invention, the present invention further provides a navigation method comprising the steps of: inputting dimension data of a vehicle through an input module; storing a plurality of sections through a storing module, and each of the sections having geometric bending data; using a routing module to filter each section and a bending road consisted of the plurality of sections passable by the vehicle according to the dimension data of the vehicle and the geometric bending data of each section, and planning a navigation path of the vehicle according to a filter result, a start address and a destination address; and displaying each the section and the navigation path from a display module.

Preferably, the navigation method further comprises the steps of:

filtering each section passable by the vehicle by the routing module according to the dimension data of the vehicle and limit data of each section, and the limit data including a vehicle type, a road load limit, a road height limit and a road width limit; and using the routing module to filter each section or a bending road consisted of the plurality of sections passable by the vehicle according to the equation:

$${W}^{2} + 4 RW > 4 {B}^{2} + 8 rB + \frac{{L}^{2} + 1.1 Ld + 0.3025}{1.6650} ;$$

Wherein, W is the road width, R is the minimum external turning radius, r is the minimum internal turning radius, B is the car width, L is the car length, and d is the front suspension length, and if the geometric bending data of any of the sections fail to satisfy said equation, the routing module will determine that the vehicle is unable to pass through the section.

From the above said, the navigation device and method in accordance with the present invention can filter a road passable by the vehicle according to the geometric bending data of each section and the dimension data of the vehicle and plan a navigation path according to the filter result to avoid the situation of a car that is driven by the user and cannot pass through a path planed by the navigation device.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a block diagram of a navigation device of the present invention;

FIG. 2 is a schematic view of dimension data and geometric bending data of a navigation device of the present invention;

FIG. 3 is a first schematic view of a bending road consisted of a plurality of sections;

FIG. 4 is a second schematic view of a bending road consisted of a plurality of sections;

FIG. 5 is a third schematic view of a bending road consisted of a plurality of sections;

FIG. 6 is a fourth schematic view of a bending road consisted of a plurality of sections; and

FIG. 7 is a flow chart view of a navigation method of the present invention.

### DETAILED DESCRIPTION OF THE PREFERRED EMBODIMENTS

The technical content of the present invention will become apparent by the detailed description of the following embodiments and the illustration of related drawings as follows. These embodiments and drawings are provided for the purpose of illustrating the present invention, but not intended for limiting the scope of the invention. For simplicity, same numerals are used for presenting respective same elements as described in the embodiments and illustrated in the drawings.

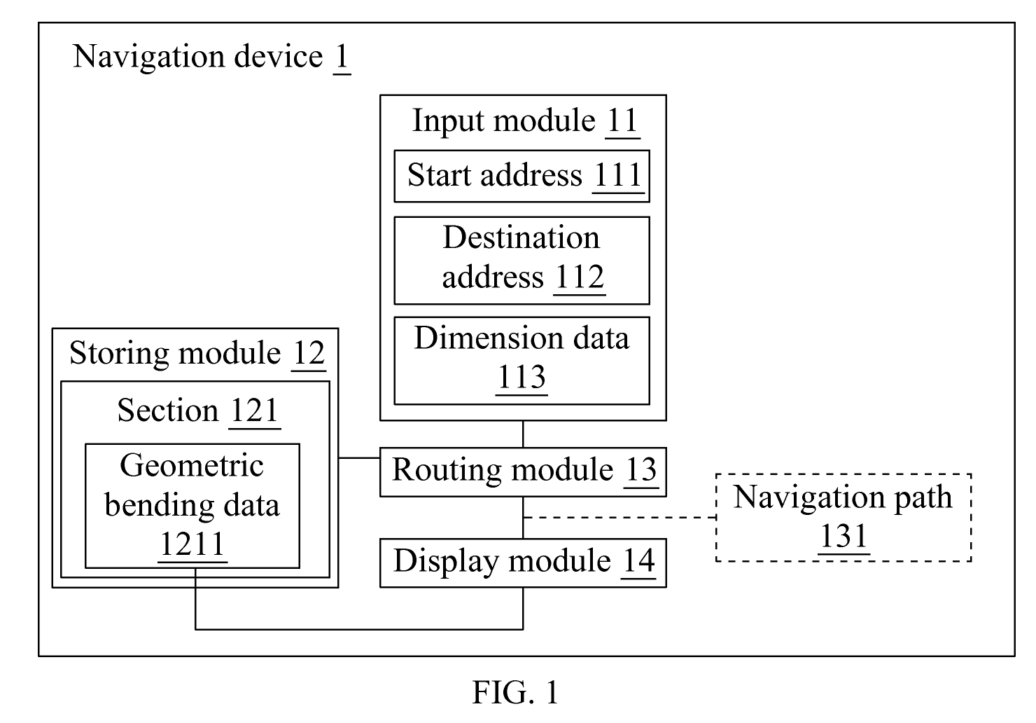

With reference to FIG. 1 for a block diagram of a navigation device of the present invention, the navigation device 1 comprises an input module 11, a storing module 12, a routing module 13 and a display module 14. Wherein, the routing module 13 can be a central processing unit (CPU) or a micro-processing unit, and the storing module 14 can be an Advanced Technology Attachment (ATA) hard disk, a Serial Advanced Technology Attachment (SATA) hard disk, a Small Computer System Interface (SCSI) hard disk, a Serial Attached SCSI (SAS) hard disk, a Solid State Disk (SSD) hard disk or a flash memory, a Read-Only Memory (ROM), a Programmable ROM (PROM), an Erasable Programmable Read Only Memory (EPROM), a One Time Programmable Read Only Memory (OTPROM), an Electrically Erasable Programmable Read Only Memory (EEPROM), and the display module 14 can be a Liquid Crystal Display (LCD), a Plasma Display Panel (PDP), an Organic Light Emitting diode (OLED) display, an Active Matrix OLED (AMOLED) display or a touch panel. However, the invention is not limited to the aforementioned arrangements.

In this preferred embodiment, the navigation device 1 can be installed in a vehicle. When a user drives the vehicle, the user can input a start address 111, a destination address 112 and dimension data 113 of the driving vehicle through an input module 11 and plan a navigation path 131 by a routing module 13. Wherein, the routing module 13 filters a bending road consisted of a section 121 or a plurality of sections 121 passable by the vehicle from each section 121 according to the dimension data 113 inputted by the user and geometric bending data 1211 of the plurality of sections 121 stored in the storing module 14 and plans a navigation path 131 according to the filter result, the start address 111 and the destination address 112, and then the display module 14 displays each section 121 and the navigation path 131.

It is noteworthy that the dimension data 113 of the vehicle inputted by users can include a front suspension length d, a shaft width b, a shaft distance l, a car length L, a car width B, a car height or a car weight. The geometric bending data of each section can include a minimum internal turning radius r, a minimum external turning radius R or a road width W. Wherein, the measurements of the vehicle are taken according to the regulations as set forth in Article 37 of the Road and Traffic Safety Rules as described below. 1. Car Length: It is the length measured from a front bumper to the rear end of a car. 2. Car Width: It is the maximum width measured between the left and right side of a car body. 3. Car Height: It is the height measured from the ground to the highest point of a car. 4. Wheel Distance: It is the distance measured between the center lines of left and right tires, and the distance between the center liens of the left and right wheels is measured for two wheels. 5. Shaft Distance: It is the distance measured between the center point of a front shaft and the center point of a rear shaft. For multi-shafts, it is the distance measured between the center point of a front shaft or a front shaft set and the center point of the last shaft; and for semi-tolling vehicle, it is the distance measured between the center point of the fifth wheel and the center point of the last shaft. 6. Maximum Shaft Distance: It is the distance measured between the center point of the front shaft of the distance car and the center point of the rear shaft. 7. Rear Suspension: It is the distance measured between the center point of the last shaft and a car tail, excluding the bumpers. 8. Section Difference: If the car width is smaller than the width of a tolling vehicle, the portion of the toll vehicle beyond the car on one side is measured based on the center line of the car and the toll vehicle.

More specifically, the method for the routing module 13 to filter the section 121 passable by the vehicle from each section 121 according to the dimension data 113 and the geometric bending data 1211 is described in details below.

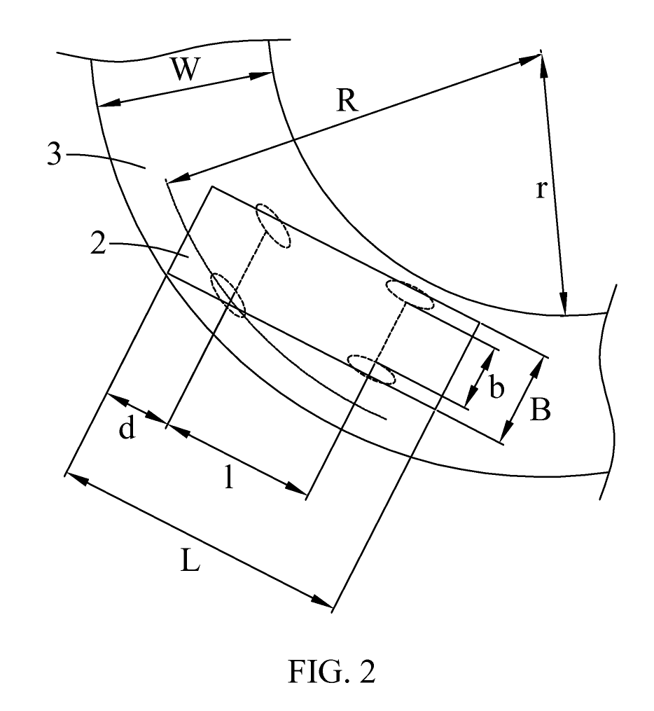

With reference to FIG. 2 for a schematic view dimension data and geometric bending data of a navigation device of the present invention, W is the road width, R is the minimum external turning radius, r is the minimum internal turning radius, B is the car width, b is the shaft width, L is the car length, l is the shaft distance, and d is the front suspension length. Wherein, the dimension data 113 are data inputted by users, and the road width W is known data of a conventional navigation device. The method of calculating the minimum internal turning radius r and the minimum external turning radius R according to the known data is described below.

The minimum internal turning radius r satisfies the following equation:

$$r = \frac{{L}_{AB}}{2} ;$$

Wherein, L_{AB} is a linear distance between a start point and an end port of a U-shaped or V-shaped bending road consisted of a plurality of sections 121, and the bending road is formed and consisted of the plurality of linear sections 121.

After the minimum internal turning radius r is calculated, the minimum external turning radius R can be calculated according to the minimum internal turning radius r and the road width W, and the minimum external turning radius R satisfies the following equation:

R=r+W/2.

Although the front suspension length d is one of the dimension data 113 inputted by users, yet the users may not know the exact front suspension length d of the vehicle 2. In addition, the front suspension length d and the car length L of the vehicle 2 are directly proportional to each other, and the front suspension length d of a vehicle 2 generally falls within a range of 1.2-1.8 m, so that the car length L can be classified to calculate the front suspension length d. In addition, the car size of vehicle 2 is related to the car length L, so that the car size can be classified to estimate the front suspension length d. For example, if the vehicle 2 is a compact car, the front suspension length d will be estimated to be 1.2 m, and if vehicle 2 is a mid-size car, the front suspension length d will be estimated to be 1.5 m, and if the vehicle is a large car, the front suspension length d will be estimated to be 1.8 m. However, the present invention is not limited to any particular method for estimating the front suspension length d.

According to FIG. 2 and the principle of Ackermann steering geometry, the minimum external turning radius R also satisfies the following equation:

R=\sqrt{(r+B)²+(l+d)²} and R=r±W.

In addition, the Chinese National Standard GB 7258-2007 specifies that “motor vehicles such as buses and closed cars (or containers) shall have a rear suspension not exceeding 65% of the shaft distance, and special operation cars and wheeled mechanical cars shall have a rear suspension calculated according to the requirements of the rear suspension and an ensured safety range, and the rear suspension of other mechanical cars shall not exceed 55% of the shaft distance. The rear suspension of any mechanical cars shall not greater than 3.5 m.” Therefore, the shaft distance l according to GB 7258-2007 satisfies the following equation:

$$l < \frac{L - d}{1.55} .$$

In summation, the aforementioned equations of the minimum external turning radius R and the shaft distance l can be used for deriving that a vehicle 2 passing through each bending road should satisfies the following necessary condition:

$${W}^{2} + 4 RW > 4 {B}^{2} + 8 rB + \frac{{L}^{2} + 1.1 Ld + 0.3025}{1.6650} .$$

In other words, if the geometric bending data 1211 of a section 121 does not satisfy the foregoing equation, the routing module 13 will determine that the vehicle 2 cannot pass through the section 121.

It is noteworthy that the storing module 14 of the navigation device 2 of the present invention further stores limit data (not shown in the figure) of each section 121, and the limit data include a vehicle type, a road load limit, a road height limit, and a road width limit. Before the dimension data 113 of the vehicle 2 and the geometric bending data 1211 of the section 121 are calculated to determine whether they satisfy the necessary condition of the bending road in each section, the limit data can be used to filter the section 121 passable by the vehicle 2, and then the foregoing necessary condition of passing through the bending road further filters the section 121 passable by the vehicle according to the filter result in advance in order to decrease the time for planning a navigation path 131 by the routing module 13.

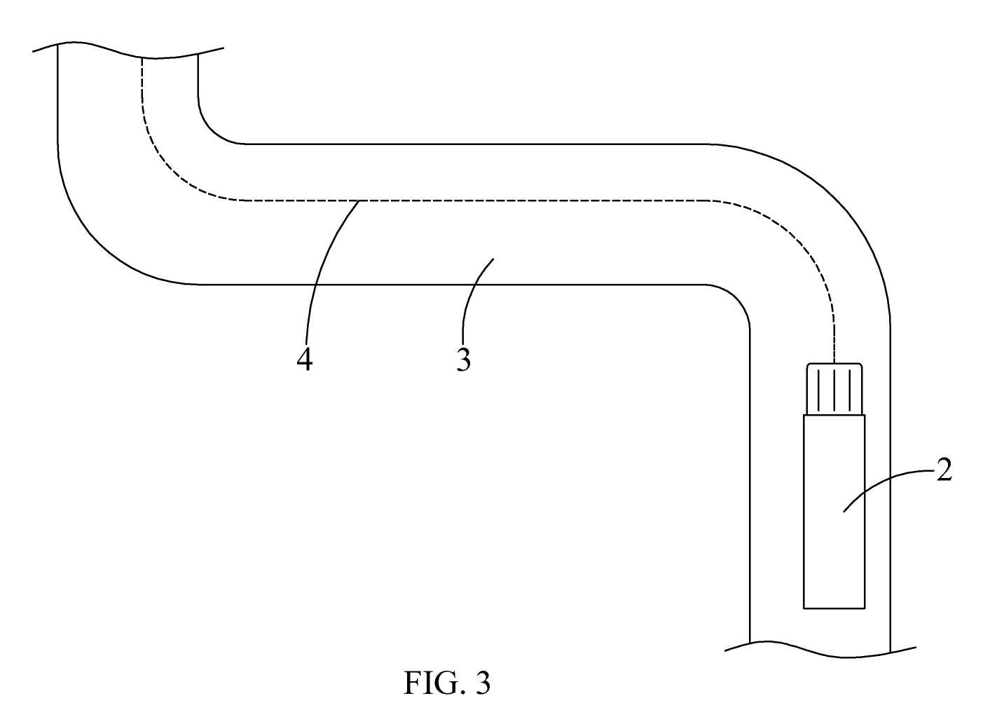

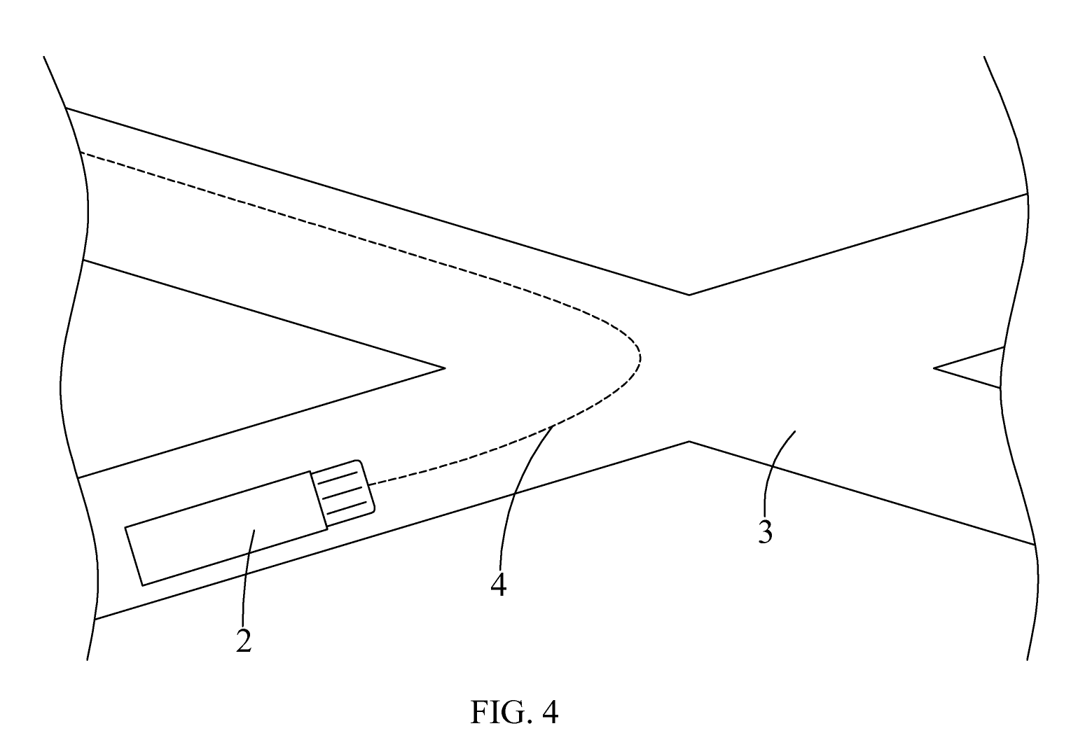

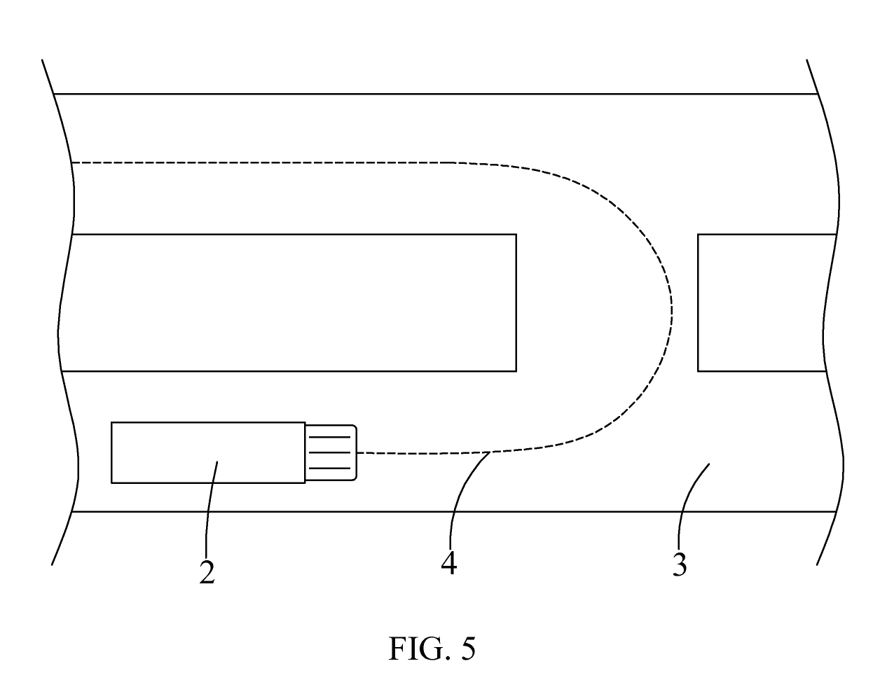

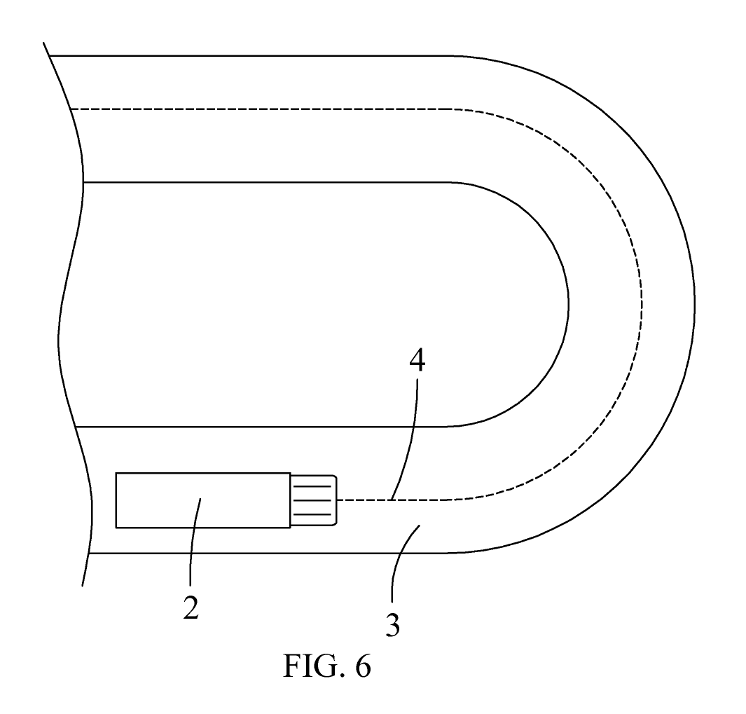

With reference to FIGS. 3 to 6 for the first to fourth schematic views of bending roads consisted of a plurality of sections respectively, the dotted line of the section 3 indicates a navigation path 4 of the vehicle 2. In general, a container or a truck may have the problem of unable to pass through a path planned by the navigation device more easily, so that a container as shown in FIGS. 3 to 6 is used as an example of the vehicle 2 for the illustration of the present invention. In addition, a general navigation device may be unable to pass through the X-shaped interaction as shown in FIG. 4 and the H-shaped intersection as shown in FIG. 5 along a navigation path. If the navigation device 1 of the present invention is installed in the vehicle 2 driven by the user, and the user plans a navigation path 4, the user has to take the dimension data of the vehicle 2 and the geometric bending data of each section into consideration to avoid the problem of the vehicle 2 being unable to pass through the navigation path 4 planned by the navigation device.

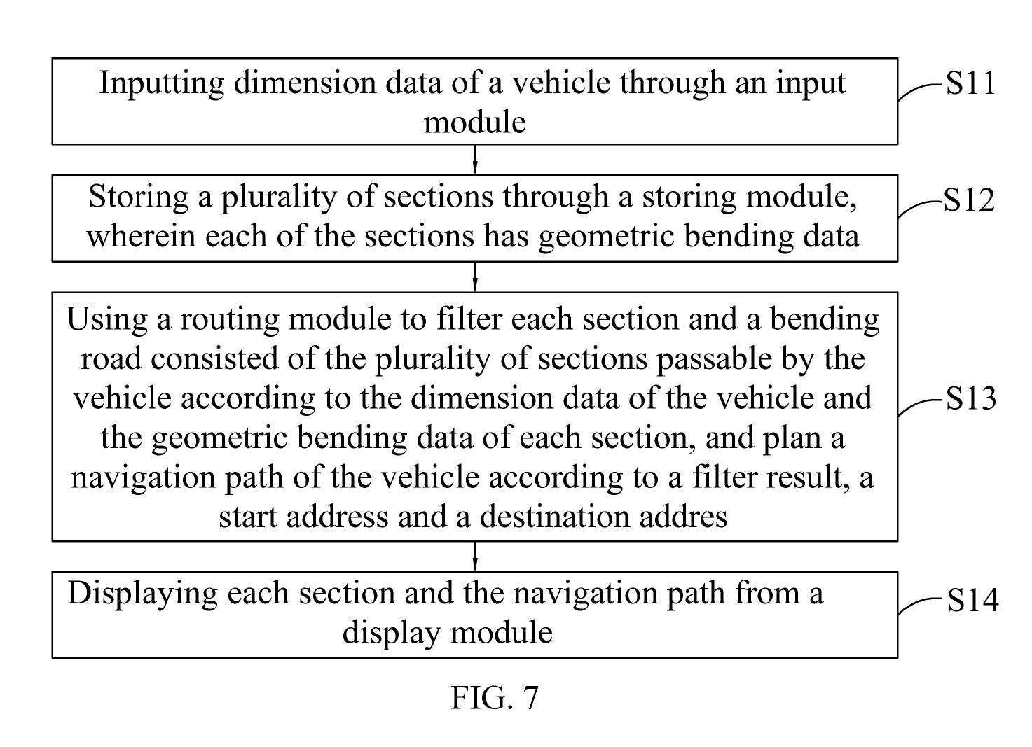

With reference to FIG. 7 for a flow chart of a navigation method of the present invention, the navigation method comprises the following steps:

S11: Inputting dimension data of a vehicle through an input module, wherein the dimension data can include a front suspension length d, a shaft width b, a shaft distance l, a car length L, a car width B, a car height or a car weight.

S12: Storing a plurality of sections through a storing module, wherein each of the sections has geometric bending data, and the geometric bending data can include a minimum internal turning radius r, a minimum external turning radius R or a road width W.

S13: Using a routing module to filter each section and a bending road consisted of the plurality of sections passable by the vehicle according to the dimension data of the vehicle and the geometric bending data of each section, and plan a navigation path of the vehicle according to a filter result, a start address and a destination address. In this step, the routing module filters a section passable by the vehicle according to the dimension data of the vehicle and the limit data of each section from each section. Wherein, the limit data can include but not limited to a vehicle type, a road load limit, a road height limit and a road width limit. Then, the following equations are used for filtering the section passable by the vehicle from each section:

$${W}^{2} + 4 RW > 4 {B}^{2} + 8 rB + \frac{{L}^{2} + 1.1 Ld + 0.3025}{1.6650} ;$$

Wherein, if the geometric bending data of a section do not satisfy the foregoing equation, the routing module will determine that the vehicle cannot pass through the section.

S14: Displaying each section and the navigation path from a display module.

The details of the navigation method and implementation of the present invention have been described in the block diagram of the navigation device of the present invention, and thus will not be repeated.

In summation of the description above, the navigation device and method of the present invention can filter a road passable by the vehicle according to the geometric bending data of each section and the dimension data of the vehicle and can plan a navigation path according to the filter result to avoid the situation of a large car such as a bus or a truck that is driven by the user and cannot pass through a path planed by the navigation device.

From the above, it can be seen that the present invention has broken though the prior art to reach the intended improved effect, and a person skilled in the art also cannot easily think about; moreover, the present application has not been published prior to applying, and the inventiveness and practicability thereof obviously comply with the patentability requirements; therefore, applying for the patentability in accordance with the Patent Act. So as to encourage inventing, the earnest request is hereby given to TIPO for granting patentability on the present invention application, and immense gratitude is herein.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A navigation device, applicable to a vehicle, comprising:
an input module, for inputting a start address, a destination address and dimension data of the vehicle;
a storing module, for storing a plurality of sections, each having geometric bending data;
a routing module, for filtering a bending road consisted of a section or the plurality of sections passable by the vehicle from each section according to dimension data and geometric bending data of each section, and planning a navigation path according to a filter result, the start address and the destination address; and
a display module, for displaying each section and the navigation path.

2. The navigation device of claim 1, wherein the dimension data include a front suspension length, a shaft width, a shaft distance, a car length, a car width, a car height or a car weight of the vehicle, and the geometric bending data include a minimum internal turning radius, a minimum external turning radius or a road width.

3. The navigation device of claim 2, wherein the minimum internal turning radius satisfies the equation of
$$r = \frac{{L}_{AB}}{2} ;$$
Wherein r is the minimum internal turning radius and L_{AB} is the linear distance between a start point and an end point of a bending road consisted of at least two sections.

4. The navigation device of claim 2, wherein the minimum external turning radius satisfies the equation
R=r+W/2;
wherein R is the minimum external turning radius, r is the minimum internal turning radius, and W is the road width.

5. The navigation device of claim 2, wherein the minimum external turning radius satisfies the equations
R=\sqrt{(r+B)²+(l+d)²} and R=r±W;
wherein R is the minimum external turning radius, r is the minimum internal turning radius, B is the car width, l is the shaft distance, d is the front suspension length, and W is the road width.

6. The navigation device of claim 2, wherein the shaft distance satisfies the equation
$$l < \frac{L - d}{1.55} ,$$
wherein 1 is the shaft distance, L is the car length, and d is the front suspension length.

7. The navigation device of claim 2, wherein each section further includes limit data, and the limit data include a vehicle type, a road load limit, a road height limit and a road width limit, and the routing module further filters each section passable by the vehicle according to the limit data and the dimension data.

8. The navigation device of claim 2, wherein the routing module further filters the section or a bending road consisted of a plurality of the sections passable by the vehicle according to the equation:
$${W}^{2} + 4 RW > 4 {B}^{2} + 8 rB + \frac{{L}^{2} + 1.1 Ld + 0.3025}{1.6650} ;$$
wherein W is the road width, R is the minimum external turning radius, r is the minimum internal turning radius, B is the car width, L is the car length, and d is the front suspension length, and if the geometric bending data of any of the sections fail to satisfy said equation, the routing module will determine that the vehicle is unable to pass through the section.

9. A navigation method, comprising the steps of:
inputting dimension data of a vehicle through an input module;
storing a plurality of sections through a storing module, and each of the sections having geometric bending data;
using a routing module to filter each section and a bending road consisted of the plurality of sections passable by the vehicle according to the dimension data of the vehicle and the geometric bending data of each section, and planning a navigation path of the vehicle according to a filter result, a start address and a destination address; and
displaying each section and the navigation path from a display module.

10. The navigation method of claim 9, further comprising the steps of:
filtering each section passable by the vehicle by the routing module according to the dimension data of the vehicle and limit data of each section, and the limit data including a vehicle type, a road load limit, a road height limit and a road width limit; and
using the routing module to filter each section or a bending road consisted of the plurality of sections passable by the vehicle according to the equation:
$${W}^{2} + 4 RW > 4 {B}^{2} + 8 rB + \frac{{L}^{2} + 1.1 Ld + 0.3025}{1.6650} ,$$
wherein W is the road width, R is the minimum external turning radius, r is the minimum internal turning radius, B is the car width, L is the car length, and d is the front suspension length, and if the geometric bending data of any of the sections fail to satisfy said equation, the routing module will determine that the vehicle is unable to pass through the section.
